(19) United States
(12) Patent Application Publication
(10) Pub. No.: US 2022/0049184 A1
(43) Pub. Date: Feb. 17, 2022

(54) PARTICULATE ADDITIVES FOR IMPROVED BIO-OIL RECOVERY

(71) Applicant: Trucent, Inc., Dexter, MI (US)

(72) Inventors: Paul W. SHEPPERD, Newark, DE (US); Kevin MOORE, Ann Arbor, MI (US); Christopher A. GRANDY, Holt, MI (US); Raymond P. ROACH, Midland, MI (US)

(21) Appl. No.: 17/386,952

(22) Filed: Jul. 28, 2021

Related U.S. Application Data
(60) Provisional application No. 63/064,507, filed on Aug. 12, 2020.

(51) Int. Cl. C11B 13/00; B01D 17/04; B01D 17/02

(52) U.S. Cl. CPC C11B 13/00; B01D 17/0217; B01D 17/047

(57) ABSTRACT

A method for recovering bio-oil from an emulsified bio-oil process stream, by adding a chemical additive system to the emulsified bio-oil process stream, wherein the chemical additive system comprises at least one surfactant and at least one hydrophobic particulate not based on silica. Bio-oil recovered from the method. A bio-oil recovery system, including a supply of emulsified bio-oil, a supply of chemical additive, wherein the chemical additive comprises at least one surfactant and at least one hydrophobic particulate not based on silica, a treatment unit for combining the chemical additive system with the emulsified bio-oil, and a centrifuge system for dewatering the treated emulsion and producing a concentrated bio-oil.

### BACKGROUND OF THE INVENTION

### 1. Technical Field

The present invention relates to recovery of bio-based oils from oil-in-water emulsions, and more directly to particulate additives for improved recovery of oil from the grain stillage of fermentative alcohol production.

### 2. Background Art

Bio-oils are natural oils of plant or animal origin. Oil-in-water emulsions are found as by-product streams in a wide variety of industries, including but not limited to biofuels, biochemicals, meat processing (including fish, poultry, and livestock processing facilities), rendering, finished food and food ingredient processing facilities. Separation of emulsified oil from the bulk water phase is practiced in such industries for several reasons, such as reuse in upstream process steps, improved operability of downstream operations, reduced organic load in downstream wastewater treatment operations, or simply recovery of the bio-oil for its inherent value and commercial sale.

A “dry-grind” process, also known as “dry-mill” process, is used for production of industrial ethanol from grain. As outlined in FIG. 1, the grain is ground, the starch portion of the grain is converted to simple sugars by the action of heat and enzymes, and the simple sugars are converted to ethanol by the action of microbes such as yeast. Ethanol is removed from the resulting mixture by distillation. The aqueous slurry remaining after distillation is known as whole stillage, and comprises unfermented grain components, inorganic salts, spent yeast, and yeast metabolic by-products. Whole stillage contains in the order of 8-15% total solids by weight. Suspended solids in whole stillage have a broad size distribution ranging from large particles of several millimeters down to fractions of a micron. Traditionally, whole stillage is separated with a decanter centrifuge into a “wet cake” stream of about 25-35% solids by weight comprising most of the large fiber particles, and a “thin stillage” stream of about 3-8% solids by weight comprising most of the fine suspended particles and dissolved solids. Depending on plant configuration, as much as 50% of thin stillage may be returned to the front-end of the plant as make-up water, also known as “backset,” for preparation of fresh grain slurry. The balance of thin stillage is concentrated in a multi-stage evaporator system to produce a viscous liquid referred to as “syrup”. The evaporation process concentrates the dissolved and suspended solids, including oil, in the thin stillage, yielding a final syrup having a total solids concentration of about 25-35%.

The concentrating effect of evaporation in the dry-grind process makes corn-oil extracted from concentrated thin stillage or syrup a profitable co-product for the ethanol industry. Most dry-grind ethanol plants now deploy high-speed centrifuges to recover distillers corn oil (DCO) from latter-stage evaporator concentrated thin stillage or the final evaporated syrup. The de-oiled syrup may be sold as a separate co-product but more often is added to wet cake, which may be sold as is or dried to produce Dried Distillers Grains with Solubles (DDGS). Wet Cake, DDGS and distillers corn oil are the primary co-products of the dry-grind ethanol process and are key to maximizing “crush margin”, the margin between the selling price of all products sold by the plant and the purchase price of input grain. DDGS is sold into the animal feed industry for its fiber, protein, and fat value. DCO is sold into the animal feed industry for dietary fat value or into the biodiesel industry as a raw material for biodiesel production. Over the past 5 years or so, DDGS has traded as a commodity in the range of $100-$200 per ton while Distillers Corn Oil has traded in the range of $0.23-$0.28 per pound ($460-$560 per ton). The significantly higher value of DCO is motivation for ethanol producers to recover as much of this valuable co-product as possible even at the expense of reducing the fat content of DDGS. Thus, ethanol producers continue to seek means of further enhancing DCO recovery.

In order to improve DCO recovery, most ethanol producers add a low dosage, typically less than 0.2% by weight of syrup, of a demulsifying surfactant or formulation thereof. Surfactants serve to destabilize the interface of the oil-in-water emulsion resulting in the coalescence of fine oil droplets into larger droplets that are more amenable to centrifugal separation. Commonly used non-ionic surfactants are of a class known as polyalkoxylated polyol fatty acid esters. A frequently used surfactant of this class is Polysorbate 80 (polyoxyethylene (20) sorbitan monooleate) wherein sorbitan (a polyol derived from sorbitol, a C6 sugar) is alkoxylated with on average 20 moles of ethylene oxide and the resultant alkoxylated polyol is esterified to oleic acid (C18:1 fatty acid). Other non-ionic surfactants of the class include polyalkoxylated fatty acid esters based on other sugars or polyols. For example, U.S. Pat. No. 9,745,540 assigned to Croda Inc. discloses a separation additive that comprises an ester of an alkoxylated non-cyclic polyol and a fatty acid wherein the non-cyclic polyol is selected from the group glycerol, neopentyl glycol, trimethylol propane, pentaerythritol, a sugar alcohol and mixtures thereof. U.S. Pat. No. 10,081,779, also assigned to Croda Inc., further discloses sucrose as useful polyol for alkoxylation and esterification with a fatty acid.

The DCO recovery surfactants are frequently formulated with other chemical additives to form a “chemical additive system”. The other additives serve to improve the oil separation efficiency and/or the handling and stability properties of the additive system. Prior patents describe and claim formulations that comprise a surfactant and fine hydrophobic or hydrophilic silica particles for improved oil recovery.

U.S. Pat. No. 10,449,469, assigned to Solenis Technologies, discloses a process additive system comprising a first surfactant, polyoxyethylene (20) sorbitan monooleate (Tween® 80), a second surfactant, an alkoxylated triglyceride, and 3-15% by weight hydrophobic silica. U.S. Pat. No. 9,353,332, assigned to Solenis Technologies, discloses a process additive system based on functionalized (alkoxylated) polyol derived from sucrose and containing 3-30% by weight hydrophobic silica. The median particle size for hydrophobic silica in the '332 patent is 0.01-200 mm as a broadly disclosed range. Specific examples in the '332 patent utilize hydrophobic silica products having median particle size of 11-13 mm or a mixture of 25% of 9 mm and 75% of 35 mm particles. The hydrophobic silica particles can be produced as a precipitated silica or a fumed silica particle. U.S. Pat. No. 8,841,469, assigned to Solenis Technologies, discloses a process additive system comprising a functionalized (alkoxylated) polyol surfactant based on sorbitol, sorbitan or isosorbide and containing up to 5 weight percent hydrophobic silica.

U.S. Pat. No. 10,005,982, assigned to Ecolab USA, discloses a process additive system including a surfactant (such as a polysorbate) and hydrophilic colloidal silica.

U.S. Pat. Nos. 9,090,851 and 9,605,233, assigned to Hydrite Chemicals, disclose a process additive system including a surfactant (such as polysorbate) and silica particles. The '851 patent discloses hydrophobic and hydrophilic silica, most preferably having a particle size less than 20 mm. The '233 patent discloses hydrophobic silica particles, preferably less than 20 mm. U.S. Pat. No. 10,087,396, assigned to Hydrite Chemicals, discloses compositions for aiding extraction of an emulsified oil comprising hydrophilic or hydrophobic silica particles and an emulsifying agent (surfactant) such as a fatty alcohol alkoxylate and fatty acid alkoxylates. U.S. Pat. No. 9,816,050, assigned to Hydrite Chemicals, discloses a method of recovering oil form a corn to ethanol process comprising adding a composition of non-ionic surfactant and optionally silicon containing particles.

U.S. Pat. No. 9,328,311, assigned to Buckman Laboratories, discloses a process additive system comprising at least one lecithin, at least one oil, optionally at least one surfactant and further (optionally) containing hydrophobic or hydrophobic silica particles. U.S. Patent Application Publication No. 2019/0159479 to Buckman discloses addition of anionic surfactant to whole stillage as a separation aid to drive more oil from whole stillage into thin stillage. The '479 application further discloses that the oil separation aid can comprise hydrophobic and hydrophilic silica.

PCT/US2016/036865 to Archer Daniel Midland Company discloses various composition embodiments of an oil recovery additive comprising a lecithin, a surfactant (non-ionic, cationic or anionic), an oil and optionally an alcohol and optionally silica. All examples specify hydrophilic silica. The compositions can be added to whole stillage, thin stillage, concentrated thin stillage or syrup.

U.S. Pat. No. 9,938,485, assigned to Polymer Ventures, discloses an oil recovery aid comprising an alkoxylated surfactant, an additive selected from a nucleant, a salt, and a mixture thereof, and a viscosity modifier, wherein the viscosity modifier is selected from water, glycerol, propylene glycol, a non-esterified glycolate homopolymer, or a mixture thereof. The '485 patent further discloses nucleants chosen from the group of a silicate, an aluminate, a titanate, a zincate, or a mixture thereof. U.S. Pat. No. 9,540,588, assigned to Polymer Ventures, discloses an oil recovery aid recovery aid comprising a polymer selected from an alkoxylated block copolymer (a poloxamer), a poloxamine, and a mixture thereof; and an inorganic salt selected from aluminum sulfate salt, an alkali metal halide salt, an alkaline earth halide salt, a pyrophosphate salt, a phosphate salt, a carbonate salt, a citrate salt, an ammonium salt, a ferric salt, a ferrous salt, or a mixture thereof. A poloxamer is a tri-block polymer having a hydrophobic core, such as polyethylene appended with polyglycol tails on the block ends. A poloxamine is a polymer that includes a plurality of polyglycols, polyglycol esters, and/or polyethyleneoxide-polypropyleneoxide groups joined by an amine. Many poloxamers and poloxamines are known to exhibit non-ionic surfactant properties. The '588 patent further discloses nucleants selected from precipitated silica, fumed silica, hydrophobic silica or mixtures thereof.

U.S. Pat. Nos. 9,255,239 and 9,399,750, assigned to Ivanhoe Industries, disclose a corn oil recovery additive comprising a surfactant (polyalkoxylated glycerol ester), an oil, and a metal oxide such as oxides of silica, titanium, zinc, iron, aluminum, cerium zirconium and combinations thereof. Ivanhoe '239 claims a generic silicon oxide additive; however, examples are specific to a hydrophobic silica of unknown source and particle size.

Various U.S. patent application publications assigned to Applied Material Solutions disclose an oil recovery additive including a surfactant and hydrophobic silica (2018/071658, 2018/071657, 2018/072963). U.S. Patent Application Publication No. 2015/0284659 discloses an oil recovery additive comprising surfactant and up to 15% by weight hydrophobic silica.

U.S. Patent Application Publication 2020/0138073, assigned to BASF, discloses oil recovery compositions and methods, the compositions including at least one additive comprising alkylphenol ethoxylate formaldehyde resin or sodium alkyl sulfate. The '073 application further discloses a composition comprising a blend of at least one anionic surfactant with at least one non-ionic surfactant in a weight ratio from about 1:20 to about 20:1. The addition of “ . . . surfactants, hydrophobic silica particles and hydrophilic silica particles and any combination thereof” can be used.

Fang, et al. investigated the synergistic effects of hydrophilic or hydrophobic silica mixed with non-ionic surfactants of varying HLB (Hydrophilic-Lipophilic Balance) as a separation aid for oil recovery from three samples of condensed corn distillers solubles (syrup) obtained from a single ethanol plant at three different seasons of the year. (Industrial Crops and Products 77 (2015) 553-559). Surfactant HLB was varied by adjusting ratios of SPAN™ 80 and TWEEN™ 80 having HLB's of 4.3 and 15 respectively, i.e., TWEEN™ 80 being more hydrophilic than SPAN™ 80. The silica particulate concentration of the separation aid was varied between 0-12.5% by weight. A dose of 1000 ppm was established for all comparisons. Fang, et al. showed that silica and TWEEN™ 80 or 50/50 TWEEN™ 80/SPAN™ 80 mixtures (HLB=9.7) were more effective than silica and SPAN™ 80. Fang, et al. further showed that the benefit of a given surfactant or surfactant/particulate combination was highly dependent on the syrup sample, with syrup having suspended solids of a finer particle size distribution being less responsive than syrup with more coarse suspended solids. More succinctly, oil recovery from syrup of finer particle size was inherently facile and the benefit of adding surfactant and particulate was less pronounced.

Evonik GmbH published a commercial product brochure which extols the benefits of their hydrophobic silica product SIPERNAT™ D10, which when mixed with an appropriate surfactant, provides significantly improved corn oil recovery (Evonik Resource Efficiency GmbH, “SIPERNAT® D10 for improved corn oil yield, December 2019).

Thus, there are broad disclosures in the prior art around the use of surfactants and silica particulates, especially hydrophobic silica particulates for improving oil recovery from an emulsified process stream such as ethanol stillage. However, there is a need for even more effective and cost-advantaged particulate additives.

### SUMMARY OF THE INVENTION

The present invention provides for a method for recovering bio-oil or other oils from a process stream containing emulsified bio-oil by adding a chemical additive system to the emulsified bio-oil process stream in an amount of 20 to 2000 ppmv (mg/L) based on the weight of the chemical additive system and the volume of the emulsified bio-oil process stream, wherein the chemical additive system includes at least one surfactant and at least one hydrophobic particulate chosen from the group consisting of fatty acids, salts of fatty acids, high melting point synthetic or semi-synthetic waxes (melting point greater than 110° C.), fatty acid coated calcium carbonate and organoclays, wherein the hydrophobic particulate comprises from 1-65% of the chemical additive system, and recovering bio-oil.

The present invention provides for bio-oil recovered from the above method.

The present invention also provides for a bio-oil recovery system, including a supply of emulsified bio-oil, a supply of chemical additive, wherein the chemical additive includes at least one surfactant and at least one hydrophobic particulate chosen from the group consisting of fatty acids, salts of fatty acids, high melting point synthetic or semi-synthetic waxes (melting point greater than 110° C.), fatty acid coated calcium carbonate and organoclays, a treatment unit for combining the chemical additive system with the emulsified bio-oil, and a centrifuge system for dewatering treated emulsion and producing a concentrated bio-oil.

### DESCRIPTION OF THE DRAWINGS

Other advantages of the present invention are readily appreciated as the same becomes better understood by reference to the following detailed description when considered in connection with the accompanying drawings wherein:

FIG. 1 shows a schematic indicating the major operations of a dry-grind ethanol process including bio-oil recovery;

FIG. 2 shows a schematic indicating potential addition points for the chemical additive system of the present invention as used for improved bio-oil recovery in a dry-grind ethanol process;

FIG. 3 shows a chart indicating oil removal efficiency as a function of total chemical additive system dose (ppm) and wt. % calcium stearate particulate in the additive with SA200 surfactant used in all cases;

FIG. 4 shows a chart indicating oil removal efficiency as a function of total chemical additive system dose (ppm) and wt. % calcium stearate particulate in the additive with P80 surfactant used in all cases; and

FIG. 5 shows a chart indicating oil removal efficiency as a function of total chemical additive system dose (ppm) and additive particulate composition (hydrophobic silica, Ca-stearate and mixtures thereof) with SA200 surfactant used in all cases.

### DETAILED DESCRIPTION OF THE INVENTION

Generally, the present invention provides for chemical additives and methods for improving the separation of oil from an emulsified process stream. The emulsified process stream can be a complex mixture of water, dissolved inorganic salts, dissolved organic acids, fine suspended solids, and oil.

The present invention provides for a method for recovering bio-oil from an emulsified bio-oil process stream, by adding a chemical additive system to the emulsified bio-oil process stream, preferably in an amount of 20 to 2000 ppmv (mg/L) based on the weight of the chemical additive system and the volume of the emulsified bio-oil process stream, wherein the chemical additive system includes at least one surfactant and at least one hydrophobic particulate, and wherein at least one hydrophobic particulate is a salt of a fatty acid or mixture of salts of fatty acids and recovering bio-oil. Preferably, the hydrophobic particulate is fatty acids, salts of fatty acids, high melting point synthetic or semi-synthetic waxes (melting point greater than 110° C.), fatty acid coated calcium carbonate, or organoclays, and the hydrophobic particulate comprises from 1-65% of the chemical additive system. The present invention provides for bio-oil recovered from the above method.

The method includes adding a chemical additive system to the process stream to enhance coalescence and gravity-based separation (e.g., centrifugal mechanical separation) of the oil from the mixture. In one embodiment, the emulsified process stream is a byproduct stream of a bio-based chemical production process. In a preferred embodiment, the bio-based chemical production process is the fermentative conversion of starch to ethanol. Corn is the most common source of starch, but this is not limiting, and the starch can further include wheat, sorghum (milo), barley, and various cellulosic feedstocks. The process stream can be, but is not limited to, mash, whole stillage, thin stillage, thin stillage concentrates (evaporated thin stillage) and/or syrup generated in a bioproduct production process. The effective dosage of the chemical additive system is less than 0.2% by weight of the process stream.

The process additive system includes a fine hydrophobic particulate and a surfactant. It has been found that certain fatty acid salts with high melting points are effective hydrophobic particulates. A preferred fatty acid salt is calcium stearate (m.p. 155° C.) (the calcium salt of stearic acid). In a preferred embodiment the chemical additive system comprises a non-ionic alkoxylated fatty ester surfactant and particulate calcium stearate. Also, high melting point synthetic and semi-synthetic waxes (m.p.>110° C.), organo-clays and coated calcium carbonate, improve the oil recovery properties of a surfactant additive system and offer improved cost performance versus incumbent particulate technology. The hydrophobic particulates are further described below.

In another embodiment of the present invention, the particulate portion of the chemical additive system is a mixture of fatty acid salts. Preferably the mixture of fatty acid salts is derived from an animal or plant-based oil, such oils naturally yielding a mixture of fatty acids upon hydrolysis. Nonetheless, synthetically produced fatty acids derived from petro-chemical feedstocks can be equally effective. The counterion for the fatty acid is preferably chosen from the group including sodium, potassium, calcium, magnesium, iron, and zinc, and mixtures thereof. The molar ratio of counterion to fatty acid of the salt of a fatty acid or mixture of salts of fatty acids can be between 0.9-1.5 times the stoichiometric molar ratio.

In another embodiment of the present invention all or a portion of the hydrophobic particulate portion of the chemical additive system includes is provided by high melting point synthetic and semi-synthetic waxes (m.p.>120° C.) (example ethylene-bis-stearamide), organo-clays, coated calcium carbonate, and mixtures thereof.

In yet another embodiment of the present invention, additional additives are included in the chemical additive system to improve the viscosity and stability of the chemical additive system. Additional additives can include, but are not limited to, oils of plant or animal origin, dispersants, thickeners, fatty alcohols, and fatty alcohol alkoxylates.

Preferably the chemical additive system includes materials that are recognized as safe such that it does not compromise the potential end use of the resulting dry distiller grain (DDG) as a feedstock.

The present invention also provides for a system for improving the recovery of oil from a byproduct stream of a fermentation ethanol process, the system including a supply of emulsified bio-oil; a supply of chemical additive, wherein the chemical additive includes at least one surfactant and at least one hydrophobic particulate of fatty acids, salts of fatty acids, high melting point synthetic or semi-synthetic waxes (melting point greater than 110° C.), fatty acid coated calcium carbonate or organoclays; a treatment unit for combining the chemical additive with the emulsified bio-oil; and a centrifuge for dewatering the treated byproduct stream to produce a concentrated bio-oil. A heating system can also be included to heat the chemical additive system from ambient to a temperature less than 100° C. prior to adding to the emulsified bio-oil.

Occurrence of Natural o/w Emulsions and the Need to Recover Oil

Separation of oil from oily wastewater or aqueous industrial byproduct streams is a universal need. Separation is practiced for many reasons including effective reuse of the oil or water, improved downstream treatment of wastewater, or the inherent value of the oil itself. The oil may be a natural oil from plant and animal sources, or petroleum based or synthetic oils. A percentage of the total available oil may occur as “free oil” that naturally separates in due time from the aqueous phase. More commonly the oil is dispersed as a stable emulsion of fine droplets, specifically referred to as an oil-in-water emulsion (o/w). In o/w emulsions, finely dispersed oil droplets are stabilized (prevented from coalescence) by the presence of surface-active chemicals known as surfactants. Surfactant molecules possess both hydrophilic and hydrophobic chemical groups and are thus able to operate at the interface of the oil and water phases. Naturally occurring emulsifying surfactants include fatty acids, phospholipids, and proteins.

The presence of fine suspended solids can further complicate the separation of oil from the aqueous phase. The surface chemistry of the suspended solid may be such that the solid particle stabilizes the o/w emulsions in the manner of a surfactant. Additionally, a hydrophobic solid can adsorb oil at the solid surface or absorb and adsorb oil within internal voids and pores.

Properly chosen surfactants can also be used to destabilize o/w emulsions by disrupting the oil-water interface of emulsified oil droplets and allowing the droplets to coalesce into larger droplets more amenable to centrifugal separation. Similarly, at an oil-solid interface, the properly chosen surfactant can act to destabilize and release adsorbed oil, making it available for coalescence and separation.

The present invention provides methods of liberating oil from complex oil-in-water mixtures. In a non-limiting application, the present invention provides methods of liberating oil from byproduct streams of grain-based ethanol production including the streams whole stillage, thin stillage, concentrated thin stillage, and syrup.

General Ethanol and DCO Process Description

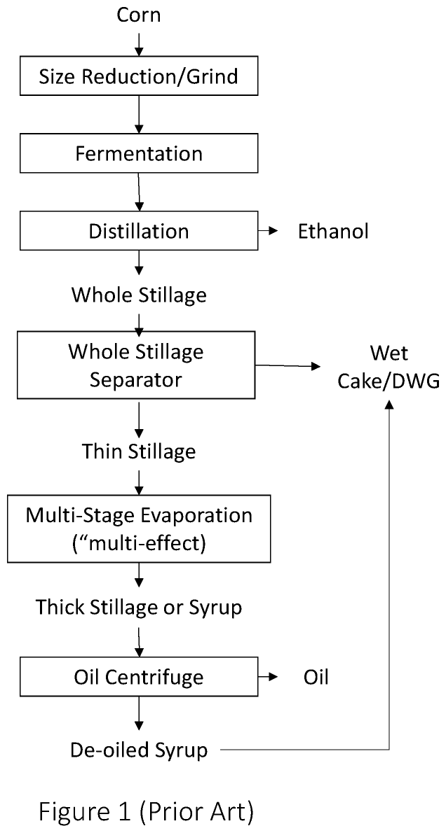

Most existing ethanol plants are so called “dry grind” plants. FIG. 1 is a process flow diagram for a typical dry mill plant (labeled PRIOR ART). In this example, corn is ground, the ground corn is mixed with hot water to form mash, and enzymes are added to convert corn starch into simple sugars. Yeast is added and the fermentation process converts the sugars into ethanol and carbon dioxide. The finished fermentation intermediate, called “beer,” is processed by distillation and ethanol is collected. Following distillation an aqueous suspension known as whole stillage remains, consisting of unfermented corn components (including oil), spent yeast and dissolved organic and inorganic compounds. Ethanol plants typically separate whole stillage via centrifugation to produce wet cake and thin stillage. A portion of thin stillage is recycled to the upstream mash step. The remainder of thin stillage is concentrated in a multi-effect evaporator, which increases the solids content and recovers condensate water for return use upstream. As the thin stillage is concentrated through the multi-effect evaporator, it is typically referred to as concentrated thin stillage or concentrate while the final evaporated stillage product is commonly referred to as syrup; however, the terms are sometimes used interchangeably in the dry-grind ethanol industry and do not impact the applicability of the present invention.

The corn oil may be separated from concentrated thin stillage or syrup with a high-speed centrifuge and collected as a higher value co-product known as Distillers Corn Oil (DCO). The corn oil yield depends on many upstream factors, such as oil & water content of the corn kernel, corn storage conditions and duration, grinding intensity, the particle size of the solids in the syrup, the process temperature of the concentrated thin stillage or syrup in the centrifuge, and the design of the separation equipment. A chemical separation aid is typically added to concentrated thin stillage or syrup prior to centrifugation to enhance the separation of the oil phase from the water and solid phases and increase the corn oil yield. De-oiled syrup may be sold separately but is typically combined with wet cake and sold as wet cake or is dried to produce distillers' dry grains with solubles (DDGS) and sold as dry animal feed.

Hydrophobic Particulates

As disclosed in the prior art, certain particulates are preferred components of the process additive system. Preferred particles are silica-based particles, most preferably hydrophobic silicas comprised of hydrophobic precipitated silicas, hydrophobic fumed silicas, and mixtures thereof. Examples of commercially available precipitated hydrophobic silicas include the SIPERNAT® D-series (Evonik Corporation, Parsippany, N.J.), and AMSIL® series (Applied Material Solutions, Elkhorn, Wis.), product lines. Examples of commercially available fumed hydrophobic silicas include the AEROSIL® R-series (Evonik Corporation, Parsippany, N.J.), AMSIL® F-series (Applied Material Solutions, Elkhorn, Wis.), CAB-O-SIL® TS-series (Cabot Corporation, Billerica, Mass.), and HDK® H-series (Wacker Chemical Corporation, Adrian, Mich.) product lines. The suggested concentration of silica-based particles is about 1% to about 20% by weight based on the total weight of the process additive system. Not to be bound to a specific theory, it is postulated that hydrophobic silica particles can act in different ways to affect oil coalescence and recovery. First, hydrophobic silica can act as a fining agent that removes protein from the aqueous phase. This effect can be particularly advantageous if the silica strips protein associated with stabilization of emulsified oil droplets and oil bodies. Second, hydrophobic silica particulates can serve as droplet nucleation sites where fine oil droplets adsorb and then coalesce into larger droplets. In the present invention, the hydrophobic particulates can be 1-65% of the chemical additive system.

Useful Salts of Fatty Acids

In the present invention it has been surprisingly found that certain salts of fatty acids can function as effective components in an oil recovery chemical additive system. Salts of fatty acids have the general formula (RCO₂⁻)ₙMⁿ⁺, where R is an alkyl carbon chain, M is a metal cation and n is the charge of the cation. When M is Na⁻ or K⁻, the fatty acid salts are often referred to as alkali or alkali metal soaps, commonly used for handwashing. When M is a divalent cation (Mg²⁺, Ca²⁺, Zn²⁺, and others) the fatty acid salts are often referred to as simply metal or metallic soaps and find use in many industrial applications including plastic fillers, mold release agents, lubricants, defoamers, and food additives.

The process for making alkali soap is known as saponification, a reaction of a triacyl glyceride (oil) with an alkali metal base such as sodium or potassium hydroxide, to form glycerol and the alkali salt of the fatty acid. The glycerol may be removed but is sometimes left in the soap.

Several well-known processes for the production of metallic soaps such as calcium or zinc stearates are described in the product literature of Baerlocher Gmbh, a major manufacturer of these products:

Precipitation or Double Decomposition process: An alkali soap is first produced via the reaction of stearic acid with sodium or potassium hydroxide in a large excess of water. A calcium salt such as calcium sulfate or calcium chloride is then added to precipitate calcium stearate. The precipitated calcium stearate is filtered, washed and dried. This double-decomposition reaction typically produces very light, fine powders with a large surface area and a more platelet morphology. These types of metallic stearates are used in applications requiring fine particle size and high surface area for the best lubrication and release properties and where special emphasis is placed on good hydrophobic properties.

Direct process: The reaction between stearic acid and metal oxide, hydroxide or carbonate takes place at an elevated temperature in a large excess of water. There are no by-products. Particle size, and thus particle surface and bulk weight are influenced by the ratio of stearic acid to water. The higher the dilution, the smaller the particles and the larger the surface will be.

Fusion process: During the fusion process, metal oxides or hydroxides and stearic acid are heated under pressure with continual stirring beyond the melting point of the metallic stearate product. As the melting point of most metallic stearates is higher than 100° C., the water resulting from the reaction escapes as steam. Therefore, a drying step is unnecessary. A variety of physical forms can be produced from this process, depending on the melting range of the final product. For relatively low or sharp melting metallic stearates, all forms (pastilles, prills, flakes and powder) are generally feasible. A very high degree of purity is achievable with the fusion process.

AV process: The proprietary Baerlocher “AV” process is a combination of the direct reaction and fusion processes. Metal oxides or hydroxides are heated according to a patented method with a fatty acid and a small quantity of water in a pressurized reactor, with the final temperature corresponding more or less to the melting point of the soap. The added water and the water resulting from the reaction are removed under reduced pressure at the end of the reaction cycle. The AV process allows the very efficient production of a variety of stoichiometries, including very pure products. AV technology is generally used to produce metallic stearates in free-flowing granule or powder forms.

The above processes allow for many product permutations. Metallic soaps can be manufactured from highly purified fatty acids to give a product having a defined fatty acid tail composition. Alternatively, metallic soaps can be manufactured using a mixture of fatty acids as would be produced via hydrolysis of natural plant or animal oils. Natural oils possess a distribution of fatty acids composed of an acyl group or carbon attached to an alkyl chain of varying chain length, degree of chain unsaturation, and internal hydroxyl content. The fatty acid mixtures resulting from oil hydrolysis can be further fractionated or purified by crystallization and/or distillation to provide fractions tailored to specific purity or need. For example, commercial stearic acid is a distilled product comprising a mixture of stearic and palmitic acid. Pure stearic acid is also available. Practitioners of metallic soap making can therefore select the metal, fatty acid profile and purity that best suits the end-market application. Selection of a high melting point, long chain saturated fatty acid such as stearic acid (C18:0, m.p. 69° C.) results in a high melting metal soap, calcium stearate (m.p. 155° C.).

In the above production methods, the amount of metal reacted with the fatty acid is normally close to stoichiometric, e.g., 1.0 Ca²⁺/2.0 R—COO⁻ for a calcium metal soap; however, products with stoichiometric excess of the metal ion are manufactured and are known as over-based products. As one commercially available example, the over-based calcium stearate Doverlube CA20 (Dover Chemical Corp., Dover, Ohio) has a mole ratio of 1.3 Ca/2 stearic acid. In addition to variable mole ratio, it can be seen from the Baerlocher's literature, that products with a range of intrinsic particle size and several physical forms are available based on the chosen process, process conditions and downstream processing.

Commercial metal soaps are also available as liquid water dispersions. Examples of aqueous dispersions containing 30-50% of calcium stearate include Calsan®65 (BASF GmbH), CA4840 (Chemical Associates, Div. of Univar USA) and Calford CD50S (Blachford Chemical Specialties). An example of an aqueous dispersion of zinc stearate is Zinc Stearate 167 (Blachford Chemical Specialties). In the dispersed aqueous metal soap products, a surfactant such as ethoxylated C11-C14 alcohol (<3% by weight) acts as the dispersant in the dispersion products. Thus, in one embodiment of the present invention, a metallic soap is provided to a chemical additive system as an aqueous dispersion. Oil dispersions and emulsions can also be used.

Commercial metal soaps applicable to the current invention are available in various particle or mesh sizes as shown in TABLE 1 below. In one embodiment the metal soap is a fine powder exhibiting less than or equal to 2% residue on a 325-mesh screen (44 um) or less than or equal to 2% residue on a 200-mesh screen (74 um).

TABLE 1

| Metal Soap | Mfc. | Product Name | Size specification |
|---|---|---|---|
| Ca-stearate | FACI | Calcium Stearate | <=10% residue on 200 |
| | | BS/G | mesh (74 μm) |
| Ca-stearate | FACI | Calcium Stearate | <=1% residue on 200 |
| | | S | mesh (74 μm) |
| Ca-stearate | FACI | Calcium Stearate | <=1% residue on 325 |
| | | SW | mesh (44 μm) |
| Ca-stearate | FACI | Calcium Stearate | <=0.1% residue on 325 |
| | | DW | mesh (44 μm) |
| Ca-stearate | Norac | COAD ® 10 | 11 μm mean particle size |
| | | | 99% thru 325 mesh |
| Ca-stearate | Norac | COAD ® 13F | 17 μm mean particle size |
| | | VG | 99% thru 200 mesh |
| | | | (74 μm) |
| Ca-stearate | Norac | Ligafood CPR- | 7 μm mean particle size |
| | | 2-K-MB | 99% thru 325 mesh |
| | | | (44 μm) |
| Ca-stearate | PMC | Ca Stearate FN | >99% thru 325 mesh |
| | Biogenix | PWD | (44 μm) |
| Mg-stearate | Norac | Ligafood MF-2- | 99% thru 200 mesh |
| | | K-MB | (74 μm) |
| Zn-stearate | Norac | COAD ® 20 | 11 μm mean particle size |
| | | | 99% thru 325 mesh |
| | | | (44 μm) |
| Zn-stearate | Norac | COAD ® 27F | 18 μm mean particle size |
| | | | 99% thru 200 mesh |
| | | | (74 μm) |

Not wishing to be bound by any particular theory, the following rationale is offered as to the effectiveness of metallic soap particulates. Similarities to hydrophobic silica can be drawn but other positive, differentiating attributes are noted. The extremely low water solubility and a high melting point, for example calcium stearate (m.p. 155° C.), assures that the metallic soap particle remains intact at typical stillage processing temperatures, 90-100° C. Like hydrophobic silica, fine metallic soap particles could serve as a fining agent that strips away hydrophobic proteins and phospholipids responsible for stabilizing oil bodies, emulsified oil droplets, and surface adsorbed oil. Like hydrophobic silica, fine metallic soap particles could also act as nucleation sites for oil drop formation and coalescence. In many instances, as demonstrated by examples included herein, metallic soaps (calcium stearate) outperform hydrophobic silica when incorporated into a surfactant-particulate system at equivalent weight percentage. It is hypothesized that the C16-C18 carbon chains pendant to the calcium stearate particle, being more similar to corn oil fatty acids than the pendant hydrophobe of hydrophobic silica, offer a preferred nucleation site for fine droplet coalescence.

Additionally, calcium stearate contributes positive nutritional benefits to ethanol plant by-products. A significant portion of DCO is sold as a valuable fat component in poultry diets. De-oiled syrup is added to wet distillers grains and dried to produce DDGS animal feed. Calcium stearate would not decrement the fat value of DCO or DDGS in animal feed products.

In an embodiment of the present invention, the chemical additive system includes a non-ionic surfactant and a metallic soap. In a more preferred embodiment, the metallic soap is a calcium stearate.

The present invention can include the salt of a fatty acid or mixture of salts of fatty acids between 10-100% by weight of the hydrophobic particulate. The salt of a fatty acid or mixture of salts of fatty acids can be a fine powder characterized as exhibiting 200 mesh (74 jam) screen residue of less than or equal to 1 percent by weight, or more preferably, 325 mesh (44 μm) screen residue of less than or equal to 1 percent by weight.

Other Hydrophobic Particulates

It is anticipated that other hydrophobic particulate solids that exhibit particle size and surface characteristics similar to metallic soaps can be utilized in the present invention. In one embodiment of the present invention, the hydrophobic particulate includes hydrophobic silicas, coated calcium carbonate, organoclays and high melting point synthetic and semi-synthetic waxes.

Organoclays and Coated Inorganic Particles. Clay minerals consist of small crystalline particles with silica-oxygen tetrahedral sheets and aluminum or magnesium octahedral sheet, where an aluminum or magnesium ion is octahedrally coordinated to six oxygens or hydroxyls. Because of isomorphous substitution of silicon ion by aluminum ion in the tetrahedral layers or similar substitution of aluminum ion by magnesium ion, smectite minerals have a net negative charged. Thus, cations like sodium, potassium and calcium may be attracted to the mineral surface to neutralize the layer charge. Organo-clays are synthesized by grafting cationic surfactants [26-29] (Such as quaternary ammonium compounds [(CH3)3NR]+ or [(CH3)2NRR′]+ where R and R′ are alkyl or aromatic hydrocarbons etc.) onto clay minerals. When hydrophobic modification of clay mineral's surface is undertaken, a variety of organo-clays can be formed. An important consequence of replacing inorganic cations with organic cations is that the clay surface can take on a hydrophobic character instead of hydrophilic.

Organophilic clays are produced from cation exchange with relatively long-chain alkylammonium cations, for example, the general form [(CH3)3NR]+ (the carbon numbers in R 12) onto 2:1 layer silicate. The long chain alkylammonium cations can form a hydrophobic partition medium within the clay interlayer, and function analogously to a bulk organic phase such as octanol or hexane. At present, the frequently used organic cations are hexadecyltrimethylammonium (HDTMA) and dioctadecyldimethyammonium (DODMA). The main carbon chains of these ions have 16 carbons and 18 carbons, respectively. The conformation and thus the ultimate sorptive characteristics of this interlayer partition phase are strongly dependent on the size of the alkyl substituent, particularly in relation to the charge density of the clay.

Organoclays are commercially available in a wide range of sizes with average particle size ranging from 0.1 μm to 1000 μm. In a preferred embodiment of the present invention, organoclays have a particle size range of about 0.1-100 μm. A wide variety of organoclay particle sizes are commercially available from, for example, Elementis (East Windsor, N.J.).

Yet another hydrophobic particulate having utility in the present invention are fatty acid coated calcium carbonates (FACC). FACC products are prepared by coating calcium carbonate with about 1-4 weight percent of fatty acid such as stearic acid. The calcium carbonate may be a ground or precipitated calcium carbonate. Not wishing to be bound by theory, FACC of similar particle size to calcium stearate soaps are anticipated as useful additives in the present invention. Commercial fatty acid coated particles anticipated to work in the present invention include for example ACMA 10T, 15T and 25 T (ACMA for Chemicals and Mining, Cairo, Egypt) having average particle sizes of about 2.6, 3.6 and 5.4 μm, respectively. Similar products having average particle size (d50) ranging from 0.9-10 μm are available from Qiangda New Materials Technology Co., Ltd (Donguan City, Guangdong Province, China).

High Melting Semi-synthetic and Synthetic Waxes. Text adapted from BYK (div. of Altana) product guide B-G 4 “Wax Emulsions and Specialty Additives”.

Wax is a broad term used to describe a general group of organic compounds. Early on, “wax” was often used as a synonym for “beeswax.” Later on, other natural materials were discovered that also showed wax-like properties and in the 20th century synthetic waxes became available.

There is no generally accepted definition of waxes. A chemical description is not very meaningful, because the involved chemistries can be very diverse and not helpful in distinguishing waxes from non-wax materials. Physical and technical properties are more suitable as definitions. Among those properties are:

Waxes are solids with a melting point above 38° C. (typically between 50° C. and 160° C.).

They have a low melt viscosity (not more than 10 Pa·s at 20° F. above the melting point).

They melt without decomposition.

The differentiation between waxes and organic polymers is not clear in all cases, e.g., polytetrafluoroethylene (PTFE) is often classified as a wax, but by definition it is not a wax because it has no melting point. Waxes come from a variety of sources. Besides natural waxes there are semi-synthetic waxes and synthetic waxes. Natural waxes can be divided into fossil waxes and waxes from living organisms (non-fossil). Paraffin wax (from crude oil) and montan wax (from coal) are good examples of fossil waxes. In the group of non-fossil waxes, beeswax and carnauba wax are typical representatives of animal and plant waxes. One drawback of natural waxes is that they are mixtures, and their compositions can vary within a certain range. Additionally, they contain impurities that cause them normally to have a yellow or even brown color. Purification such as refining and bleaching, are necessary before they can be used commercially in industry. While natural waxes are still used, their significance continues to decline. Synthetic waxes can be tailored more readily for various areas of application, and their chemical composition is much more controlled.

Semi-synthetic waxes are created in the laboratory from natural raw materials. For example, amide waxes are produced by condensation of fatty acids and amines. An industrially important amide wax is ethylene bis-stearamide (EBS) formed from the reaction of ethylene diamine and stearic acid. Synthetic waxes, which include homopolymers and copolymers, are the most important group today for a wide range of applications. The first synthetic waxes on the market were the Fischer-Tropsch waxes. Other homopolymer waxes such as polyethylene (LDPE, low density polyethylene and HDPE, high density polyethylene) and polypropylene waxes shortly followed. In addition to polymerization, depolymerization of high molecular weight polymers (especially in the case of polypropylene) can also be used for the production of such materials.

Copolymer waxes based on ethylene vinyl acetate (EVA) and ethylene acrylic acid (EAA) are well known in coating formulations, especially in metallic (basecoat) systems.

In the present invention, waxes having melting points significantly above typical stillage and syrup operating temperatures are preferred. In a preferred embodiment of the present invention, a wax having a melting point of 120° C. is anticipated as useful as such waxes are not prone to melt or significantly deform during mixing with hot syrup or in the centrifugal oil separation process. Based on these selection principles, natural waxes are not preferred, and more preferred candidates include micronized polyolefins, polyolefin emulsions, micronized ethylene-bis-stearamide (EBS), EBS emulsions, and hybrid polyolefin-EBS waxes. In the aqueous emulsion form, a surfactant is used to stabilize the emulsified particles. Many semi-synthetic and synthetic high melting point wax products can be found in commercial product literature, for example Deurex AG (Elsteraue, Germany), BYK-Chemie GmbH (div. of Altana AG; Wesel, Germany).

Surfactants

The use of a corn oil separation additive is intended to increase the corn oil yield. As described previously, various surfactants have been disclosed in the prior art and commercialized as primary active ingredients in corn oil separation additives. Not wishing to be bound by any particular theory, various hypotheses have been put forth in the prior art as to why surfactants are effective. In the corn kernel germ, oil is stored in small (˜1 μm diameter) protein encased vesicles known as oil bodies. During the grinding, mashing, fermentation and downstream stillage processing steps of dry-grind ethanol production, a large fraction of the oil bodies is disrupted, and oil is liberated. As a result of the enzymatic, agitation and heat history of cumulative process steps, a small portion of the liberated oil can readily separate as “free” oil upon standing; however, a greater portion of the liberated oil becomes emulsified and adsorbed in stillage due to the presence of emulsifying proteins and phospholipids while residual starch and cellulosic fines present may assist in stabilization. A portion of the liberated oil will also become adsorbed onto or absorbed into stillage solid components such as fiber particles and yeast cell walls. Another portion of oil remains entrapped in intact oil bodies. By assimilation and displacement of natural surfactants at oil/water and oil/solid interfaces, surfactants can act as follows to liberate several oil portions: 1) demulsifying the bulk emulsified oil, 2) desorbing adsorbed and absorbed oil, 3) disrupting the surface of intact oil bodies. Cumulatively, these actions cause fine oil droplets to coalesce into the larger droplets amenable to centrifugal separation.

The most frequently prescribed surfactants are non-ionic, especially polyalkoxylated fatty esters of polyols—fatty esters of C3-C6 polyols and fatty esters of alkoxylated C3-C6 polyols, including cyclic and non-cyclic polyols, including glycerol, sorbitol, sorbitan, isosorbide, sucrose (a C6 sugar dimer) and other sugar alcohols, or mixtures thereof. Fatty acids of the disclosed surfactants range from C6-C22 carbon chain length, with C12-C18 being most often prescribed. Ethylene oxide (EO), propylene oxide (PO) and EO/PO mixtures are the commonly disclosed alkoxylation agents. The number and length of fatty acid chains establish relative lipophilicity while the polyol and degree of alkoxylation establish the relative hydrophilicity of the surfactant structure. Other non-ionic surfactants prescribed in the prior art include fatty alcohol alkoxylates, fatty acid alkoxylates, alkoxylated plant or animal oils and fats, alkoxylated mono- and di-glycerides. Combinations of non-ionic surfactants are also prescribed. In embodiments of the present invention the chemical additive system contains non-ionic surfactants.

In an embodiment of the present invention, the chemical additive system can also contain an anionic surfactant, such as a sulfonated surfactant. Kadioglu et al. (J Am Oil Chem Soc, 2010, 88: 863-869) showed that an aqueous solution of a sulfonated fatty alkoxylate was effective in extracting corn oil from ground corn germ.

Surfactants can be between 2% and 95% by weight of the chemical additive system.

Other Additives

Other non-demulsifying additives can be included or formulated into the chemical additive system for improved rheology and sedimentation stability of the additive system. Such additives are useful for improved viscosity (flow properties) or storage stability, e.g., mitigation of settling or precipitation. Viscosity modifiers may be selected from the group consisting of water, glycerol, propylene glycol, fatty acid methyl esters, vegetable oils, mineral oils, fatty alcohols, monoglycerides, diglycerides, triglycerides, plant based oils, animal based oils, derivatized cellulose, starches or gums, alkoxylated plant or animal based oils, fatty esters, or a mixture thereof. Examples of suspending agents that may be useful in the chemical additive system include gums and cellulosic suspending agents. The other additives may be useful in the range of 0.1-50 weight percent based on total weight of the chemical additive system.

### PARTICULAR EMBODIMENTS OF THE INVENTION

In one embodiment of the present invention, a method is provided for improving the recovery of a bio-based oil from an emulsified process stream, by adding a chemical additive system to the process stream at a dosage of 20-2000 mg/L (ppm) based on the weight of the chemical additive system and the volume of the emulsified process stream, wherein the chemical additive system comprises a surfactant and a metal soap, and wherein the metal soap comprises from 1-50 percent by weight of the chemical additive system. The metal soap can be a pure metal soap or a mixture of metal soaps. The metal soap can further include alkali soaps possessing monovalent alkali cations such as sodium and potassium. In a preferred embodiment the cation of the metal soap includes divalent metal cations including calcium, magnesium, zinc and mixtures thereof. The average carbon chain length of the fatty acid group of the metal soap of the present invention is preferably in the range of 11.5-22.5. The metal soap of the present invention preferably has an average particle size between 1-75 micrometers. The metal soap can be formulated into the chemical additive system as a dry solid particle or as a particle dispersed in a water base or in an oil base.

In a preferred embodiment of the present invention, the chemical additive system includes a metal soap and a surfactant chosen from the surfactant classes non-ionic and anionic. A preferred surfactant class is non-ionic, and most preferably non-ionic surfactants comprising fatty esters of C3-C6 polyols and fatty esters of alkoxylated C3-C6 polyols, including cyclic and non-cyclic polyols, including glycerol, sorbitol, sorbitan, isosorbide, sucrose (a dimer of C6 sugars) and other sugar alcohols. The surfactant can comprise between 5-95 percent by weight of the total chemical additive system.

In another embodiment of the present invention, the chemical additive system includes a surfactant, a metal soap, and one or more other hydrophobic particles including hydrophobic silica, coated calcium carbonate, organoclays and high melting point synthetic and semi-synthetic waxes. The other hydrophobic particles preferably have an average particle size in the range of 1-75 micrometers, and between 5-95% by weight the total hydrophobic particulate fraction of the chemical additive system. The total amount of metal soap and other hydrophobic particles is between 1-50% by weight of the chemical additive system.

In yet another embodiment of the present invention, the metal soap is derived from fatty acids of a plant or animal oil. In a particular embodiment, the oil is distillers corn oil, wherein the DCO is hydrolyzed by means known to those skilled in the art and the resultant free fatty acids are reacted with an alkali metal to yield a metal soap.

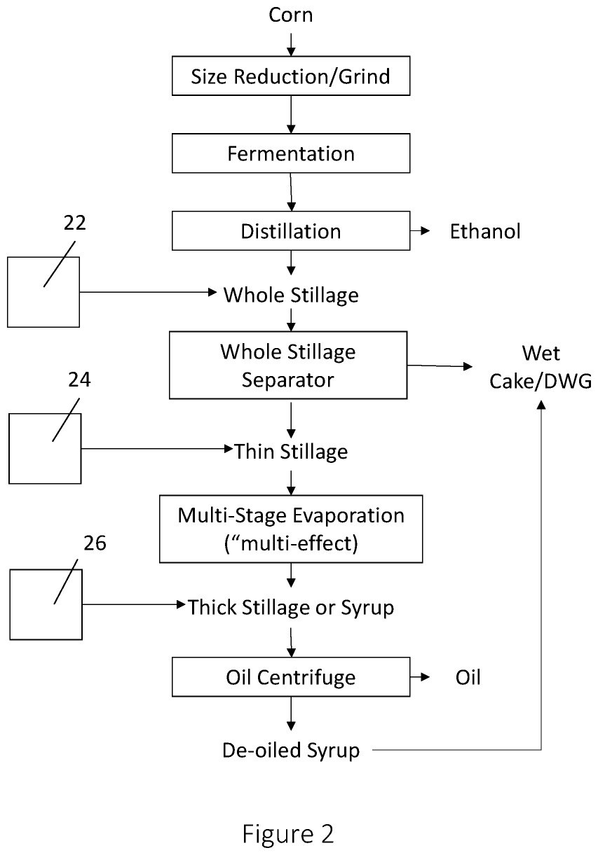

The chemical additive system of the present invention can be added at various points in the dry-grind ethanol process as shown in FIG. 2, such as prior to the oil separation step, or can be added at more than one addition point. The chemical additive system can be provided to whole stillage, thin stillage, concentrated thin stillage or syrup, and combinations thereof. The chemical additive system is preferably stored in vessels 22, 24, 26 that feed the respective addition points. One skilled in the art will recognize that separate vessels are not a necessity and a single common vessel or even the shipping container itself (for example a bulk liquid drum or tote) can be used for distribution of the chemical additive system to the selected addition point or points. Further, one skilled in the art will recognize that a proper metering device such as a metering pump and flowmeter will assure accurate delivery of the chemical additive system.

In another embodiment of the present invention, the surfactant and particulate components of the chemical additive system can be delivered separately to the selected addition point or points. For example, a liquid surfactant and a liquid dispersion of hydrophobic particulates can be dispensed from separate storage vessels with separate metering systems. Such an arrangement provides flexibility in control of dosage of each component to the oil recovery process. More complex delivery systems can be contemplated by an engineer skilled in the art if more than one of any of the surfactant, particulate and modifying agent components are envisioned for a specific plant or installation.

The invention is further described in detail by reference to the following experimental examples. These examples are provided for the purpose of illustration only and are not intended to be limiting unless otherwise specified. Thus, the invention should in no way be construed as being limited to the following examples, but rather, should be construed to encompass any and all variations which become evident as a result of the teaching provided herein.

### Example 1—Babcock Centrifuge Method for Determination of Oil Removal Efficiency (% ORE)

The efficiency of oil extraction from corn stillage syrup for a given additive system was determined by a laboratory method. The key steps of the method are thorough mixing of syrup (feed) and additive, heating to an elevated temperature (93° C.) with agitation, and high-speed centrifugal separation in a Babcock centrifuge bottle. Babcock centrifuge bottles are commonly used for determination of fat content in dairy products.

Example of analytical method. To a 150 ml glass beaker was added 100 g fresh syrup from an ethanol plant and the amount of process additive required to treat 100 g syrup. Syrup with additive was heated to 93° C. with magnetic stir-bar agitation on a temperature controlled stirring hot plate. After three minutes at 93° C., approximately 50 ml hot sample was transferred into two pre-weighed Babcock 50 ml centrifuge bottles (Kimble Glass), weighed again and the weight of added sample recorded. The bottles were placed in a heated Babcock centrifuge (Garver “Electrifuge” model 112G) and spun for 10 minutes at 1600×g. The volume of free oil in the graduated neck of the Babcock bottle was recorded to the nearest 0.05 ml and the grams of oil calculated by multiplying volume (ml) by specific gravity (0.875 for DCO). The weight percentage of recovered oil in the treated sample was calculated as [grams oil in Babcock bottle]/[total grams of sample in the Babcock bottle]×100%. The theoretical amount of oil available in fresh untreated syrup was previously determined by a method adapted and modified from AOAC 954.02. Method modifications included first hydrolysis with strong base prior to strong acid hydrolysis and use of hexane as the extraction solvent. Oil Removal Efficiency (% ORE) was calculated as: (wt. % Babcock Oil in treated syrup sample)/(wt. % Hexane extracted oil in untreated syrup sample)×100%. Results are presented as the average ORE for the two replicate Babcock samples.

### Example 2—Effect of Calcium Stearate Addition to Non-Ionic Surfactants on Oil Removal Efficiency

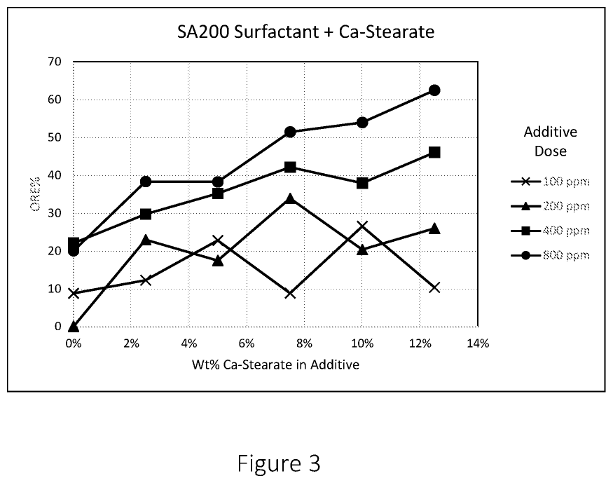

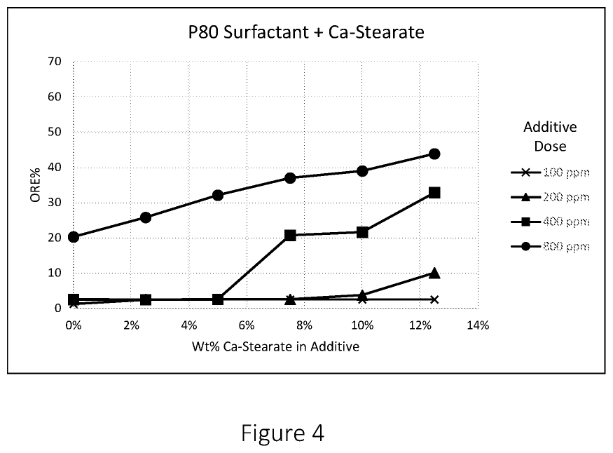

A fresh sample of the untreated feed (syrup) was obtained from a US Midwest ethanol plant and treated in the lab with varying dosages of a chemical additive system per the method of EXAMPLE 1. The chemical additive system comprised one of two non-ionic surfactants and 0-12.5 wt. % of fine calcium stearate particles (“Calcium Stearate FN PWD”, PMC Biogenix Inc., Memphis, Tenn.). A sieve analysis of the calcium stearate showed 99.94% passing 325 mesh (44 μm). Applied dosages of the chemical additive system were varied between 100-800 ppm based on weight of syrup. Results are shown in FIG. 3 (SA200, Croda Inc., polyalkoxylated sucrose fatty ester) and FIG. 4 (Polysorbate 80, TWEEN™ 80, Croda Inc., polyalkoxylated sorbitan fatty ester). It was generally observed that a dosage of 400 ppm or greater of either surfactant was required for good performance. For SA200 surfactant, inclusion of 2.5-12.5 wt. % calcium-stearate improved % ORE at all dosages. For P80 surfactant, the impact of calcium-stearate was more pronounced at higher dosages (400, 800 ppm). The results of EXAMPLE 2 demonstrate the benefit of including a fine particulate salt of a fatty acid as a component of a surfactant-based oil extraction aid.

### Example 3—Mixed Silica and Fatty Acid Salt Particulates and Impact on ORE

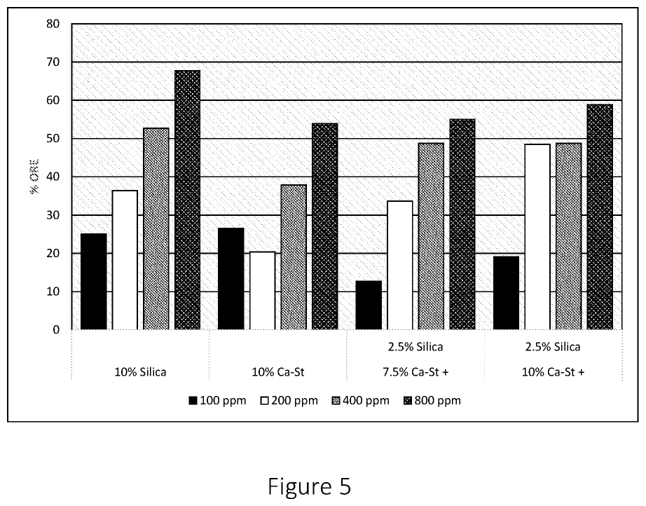

A fresh sample of the untreated feed (syrup) was obtained from a US Midwest ethanol plant and treated in the lab with increasing dosages of a chemical additive system. % ORE was determined by the method of EXAMPLE 1. The additive system comprised SA200 as the base surfactant with 10-12.5 wt. % of hydrophobic silica (unknown supplier) and/or calcium stearate (“Calcium Stearate FN PWD”, PMC Biogenix). ORE results of FIG. 5 demonstrate that mixtures of a particulate salt of a fatty acid can effectively contribute to the performance of other hydrophobic particulates (silica) in an oil extraction system.

### Example 4—Impact of Cation of Fatty Acid Salt Particulate on ORE

A fresh sample of the untreated feed (syrup) was obtained from a US Midwest ethanol plant and treated in the lab with increasing dosages of a chemical additive system. % ORE was determined by the method of EXAMPLE 1. The additive system comprised SA200 as the base surfactant plus 10 wt. % of either calcium stearate (“Calcium Stearate FN PWD”, PMC Biogenix) or magnesium stearate (Sigma Chemical). The results of TABLE 2 below indicate that the magnesium salt of a fatty acid can improve the oil removal efficiency of a surfactant-based chemical additive system. One skilled in the art will recognize that further optimization can be obtained through appropriate selection of metal salt composition, particle size and dosage.

TABLE 2

| | % ORE | |
|---|---|---|
| Dose (ppm) | 10% Ca-Stearate | 10% Mg-Stearate |
| 100 | 26.56 | 10.04 |
| 200 | 20.37 | 25.09 |
| 400 | 37.88 | 30.11 |
| 800 | 53.93 | 33.87 |

### Example 5—Preparation of Other Fatty Acid Metal Soaps and Use Thereof

A metal soap is prepared for example from distillers corn oil (DCO) obtained from a typical corn ethanol facility. The DCO is hydrolyzed to free fatty acids by any of the following methods well known to those skilled in the art: (a) base hydrolysis followed by acidification, (b) enzymatic (lipase) hydrolysis, or (c) hydrothermal hydrolysis at high pressure and temperature.

The crude hydrolysate obtained from any of the known methods may be purified by distillation and thus producing a fatty acid product having greater than 98% by weight free fatty acids. The acid value of the distillate is determined by titration. To form for example the calcium soap, calcium oxide powder is added to the distillate at an equivalency of ½ mol Ca per mol KOH/g sample. Given that the molecular weights of CaO and KOH are nearly identical, a distillate having an acid value of 200 mg KOH/g is treated with 100 mg CaO. Water is generated as a result of the neutralization process and the calcium soap precipitates as it forms. The soap is oven dried in air (110° C.), and ground to a fine powder. The produced calcium soap of DCO fatty acids can be used in a chemical additive system of the present invention in the same manner and similar proportions as commercial calcium stearate particulates. This example is not to be construed as limiting and one skilled in the art will recognize that many natural oils can serve as sources of fatty acids for production of metal soaps. Nor should the example be limited to calcium and other metals, and for example, magnesium and zinc can serve as the cation.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology, which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. A method for recovering bio-oil from an emulsified bio-oil process stream, including the steps of:
adding a chemical additive system to the emulsified bio-oil process stream in an amount of 20 to 2000 ppmv (mg/L) based on the weight of the chemical additive system and the volume of the emulsified bio-oil process stream, wherein the chemical additive system comprises at least one surfactant and at least one hydrophobic particulate chosen from the group consisting of fatty acids, salts of fatty acids, high melting point synthetic or semi-synthetic waxes (melting point greater than 110° C.), fatty acid coated calcium carbonate and organoclays;
wherein the hydrophobic particulate comprises from 1-65% of the chemical additive system; and
recovering bio-oil.

2. The method of claim 1, wherein the emulsified bio-oil process stream is a process stream of an ethanol production process.

3. The method of claim 2, wherein the emulsified bio-oil process stream is chosen from the group consisting of whole stillage, thin stillage, concentrated thin stillage, and syrup.

4. The method of claim 1, wherein fatty acids or salts of fatty acids comprise between 10-100% by weight of the hydrophobic particulate.

5. The method of claim 1, wherein the salts of fatty acids comprise a counterion chosen from the group consisting of sodium, potassium, calcium, magnesium, iron, zinc, and mixtures thereof.

6. The method of claim 5, wherein the molar ratio of counterion to fatty acid in the salts of fatty acids is between 0.9-1.5 times the stoichiometric molar ratio.

7. The method of claim 1, wherein the fatty acids or salts of fatty acids have an average fatty acid chain length of between 11.5 and 22.5 carbon atoms.

8. The method of claim 1, wherein the salts of fatty acids are derived from a mixture of fatty acids from an oil of animal or plant origin.

9. The method of claim 8, wherein the oil of plant origin is distillers corn oil.

10. The method of claim 1, wherein the salts of fatty acids are a fine powder characterized as exhibiting 200 mesh (74 μm) screen residue of less than or equal to 1 percent by weight.

11. The method of claim 10, wherein the salts of fatty acids are a fine powder characterized as exhibiting 325 mesh (44 μm) screen residue of less than or equal to 1 percent by weight.

12. The method of claim 1, wherein the high melting point synthetic or semi-synthetic wax is ethylene-bis-stearamide.

13. The method of claim 1, wherein the at least one hydrophobic particulate has an average particle size between 1-75 micrometers.

14. The method of claim 1, wherein the salts of fatty acids are calcium salts of stearic acid.

15. The method of claim 14, wherein the calcium salt of stearic acid is provided as a dry powder or a liquid dispersion.

16. The method of claim 15, wherein the liquid dispersion is chosen from the group consisting of aqueous dispersion, oil dispersions, and emulsions.

17. The method of claim 1, wherein the surfactant comprises between 2% and 95% by weight of the chemical additive system.

18. The method of claim 1, wherein the surfactant is chosen from the group consisting of non-ionic surfactants and ionic surfactants.

19. The method of claim 18, wherein the non-ionic surfactant is a polyalkoxylated fatty ester of a polyol.

20. The method of claim 19, wherein the polyol is chosen from the group consisting of sorbitan, sorbitol, glycerol, sucrose, and mixtures thereof.

21. The method of claim 18, wherein the ionic surfactant is a sulfonated surfactant.

22. The method of claim 1 wherein the chemical additive system further includes additional modifying additives comprising from 0.1% to 50% of the total weight of the process additive system, and wherein at least one additional additive is selected from the group consisting of monoglycerides, diglycerides, triglycerides, plant-based oils, animal-based oils, alkoxylated plant-based or animal-based oils, fatty esters, and combinations thereof.

23. The method of claim 1, wherein the chemical additive system is added to an emulsified bio-oil process stream prior to an oil separation step wherein the emulsified bio-oil process stream is selected from the group consisting of whole stillage, thin stillage, concentrated thin stillage, syrup, and combinations thereof.

24. The method of claim 1, wherein separate components of the chemical additive system are added to the emulsified bio-oil process stream at more than one addition point.

25. Bio-oil recovered from the method of claim 1.

26. A bio-oil recovery system, comprising:
a supply of emulsified bio-oil;
a supply of chemical additive, wherein said chemical additive comprises at least one surfactant and at least one hydrophobic particulate chosen from the group consisting of fatty acids, salts of fatty acids, high melting point synthetic or semi-synthetic waxes (melting point greater than 110° C.), fatty acid coated calcium carbonate and organoclays;
a treatment unit for combining the chemical additive system with said emulsified bio-oil; and
a centrifuge system for dewatering treated emulsion and producing a concentrated bio-oil.

27. The system of claim 26, wherein the emulsified bio-oil is a process stream of an ethanol production process.

28. The system of claim 27, wherein the process stream of an ethanol production process is chosen from the group consisting of whole stillage, thin stillage, concentrated thin stillage, and syrup.

29. The system of claim 26, further including a means of heating said chemical additive system from ambient to a temperature less than 100° C. prior to adding to said emulsified bio-oil.

30. The system of claim 26, wherein components of the chemical additive system are added to the emulsified bio-oil via more than one addition point.
